(19) United States
(12) Patent Application Publication
(10) Pub. No.: US 2005/0276883 A1
(43) Pub. Date: Dec. 15, 2005

(54) System and method for dispensing a dairy product

(76) Inventors: George Malcolm Jeffrey, Oakville (CA); Lee Scott Hoover, Toronto (CA); Barry Gordon Waddell, London (CA); Liberatore Antonio Trombetta, Ancasler (CA)

Correspondence Address: MARKS & CLERK, 1075 NORTH SERVICE ROAD WEST, SUITE 203, OAKVILLE, ON, L6M 2G2, CA

(21) Appl. No.: 10/865,894

(22) Filed: Jun. 14, 2004

(51) Int. Cl. A23G 3/00

(52) U.S. Cl. 426/106

(57) ABSTRACT

A multi-component liquid dairy product dispensing system is provided which preferably utilizes an ultrasonic mixing chamber to essentially instantaneously combine and reconstitute liquid dairy product streams of various concentrations, with or without water, into a single homogeneous final liquid dairy product. Depending on the ratio of the liquid dairy products, a resultant liquid dairy product is provided which possess the same quality and attributes of the traditional liquid dairy products known by consumers, and can meet the regulatory standards for identification for various milk and cream products with respect to milk solids and fat content percentages. The liquid dairy product streams are preferably aseptic products in order to increase their shelf-life and stability. The resultant liquid dairy product dispensing system provides a system which is capable of rapidly providing a variety of liquid dairy products.

### FIELD OF THE INVENTION

The present invention relates to the field of dispensing of liquid products, and in particular, relates to a method and apparatus for the dispensing of liquid dairy products having a selectable range of fat and milk solid content.

### BACKGROUND OF THE INVENTION

Milk is an oil-in-water emulsion of fat globules which is dispersed in a continuous skim milk phase. As such, milk comprises water, fat (also termed as “milk fat” or “butter fat”), and milk solids such as proteins, minerals, ash, and the like. If left to stand, the fat globules will agglomerate and rise to the top of the skim milk phase where they can be separated from the skim milk phase. As such, it is common practice in the dairy industry to be able to produce a wide range of liquid dairy products, based on milk, ranging from, for example skim milk (with little or no fat globules) to creams having up to, for example 45 to 50% fat dispersed in a skim milk phase. A wide range of dairy products with different fat contents are readily available, and commonly used. These can include common liquid dairy products having fat contents of 0% (skim milk), 1%, 2%, 3.25%, 10%, 18%, 35%, or even higher depending on the amount of fat desired in a milk or a cream material.

As such, there are a wide range of liquid dairy products available which are commonly used for different purposes, or as a result of different consumer preferences. For the purposes of the present application, the term milk is used interchangeably with the term “dairy” to include all liquid products produced from milk.

In a retail setting, such as for example, a restaurant or a coffee shop, it is frequently necessary to have a variety of dairy products available to meet the preferences of the consumer, or for different applications. Some of these applications may be low volume, while others might be much higher volume. As such, the owner of the retail outlet must maintain a supply of all of the necessary liquid dairy products, and maintain adequate inventories of each product to cover their use of the selected dairy product.

Also, with low volume materials, it may be necessary to discard product since dairy products typically have a limited shelf life.

Further, it is known in the retail and industrial environments, that beverages can be made from individual components which are generally mixed together and dispensed by a dispensing system. These dispensing systems may be manual or automatic and may operate continuously or in discrete dispensation steps. Liquid dispensation systems typically involve at least a liquid receptacle for holding the liquid and a pump for dispensing the liquid into a consumable portion. This can include mixing water with a flavoured concentrate to produce a soft drink, reconstituting a juice drink by the addition of water to a juice concentrate, or various other techniques. A variety of these types of liquid dispensing systems are commercially available. Systems are also known which provide gas, or carbonation to liquid materials by the addition of, for example, fluid CO₂ to a liquid material.

In some circumstances, two liquids may be dispensed together by the same apparatus. Typically, an apparatus that allows mixing of two liquids results in effectively a better mixed consumer beverage product. As an example, two liquids can be dispensed using a dual liquid dispenser package, as disclosed in U.S. Pat. No. 4,774,057 to Uffenheimer et al. This patent discloses a dispenser package containing two separate liquid dispensing chambers, two liquid reservoirs, and liquid supply channels connecting the reservoirs to the chambers. However, this device is primarily direct to a dispenser which is adapted to provide two reagent liquids to automated liquid analysis system.

Other dispensing systems include U.S. Pat. No. 3,987,715 to Muller which provides an apparatus for mixing a solid or powdered material such as a powdered soup, to a hot liquid, and mixing the two to provide a liquid soup for dispensing.

Similarly, Vanderhoff et al., in U.S. Pat. No. 4,177,177 describe an apparatus for producing an aqueous polymer emulsion from an insoluble polymer phase by use of a suitable emulsifier.

U.S. Pat. No. 4,923,093 to Gerber describes a flavour dispensing device wherein a liquid flavour component can be added to a solid frozen material, such as for example, ice cream.

Additionally, U.S. patent Publication No. 2001/0026821 A1, published Oct. 4, 2001, also describes a two container apparatus for blending two different materials together (optionally with water as a third diluent) in order to form a final product. This system is primarily concerned with blending coffee components together in order to form a coffee product which more closely simulates freshly brewed coffee.

Further, PCT patent publication No. WO2004/004523 published Jan. 15, 2004 provides a method for the addition of steam to a milk in order to produce a hot beverage.

With respect to the milk/dairy industry, methods are also known for the modification of the milk solids and fat content of a liquid dairy product by combination of various milk products. For example, Bell in U.S. Pat. No. 4,651,898 provides a method for simply combining two different liquid milk products.

Further, O'Keefe, in U.S. Pat. No. 4,144,804 provides a milk processing system wherein heat treated milk is separated in high fat and low fat milk components and then mixed together to form milk products having a desired fat content. Similarly, Zettier et al. in U.S. Pat. No. 5,260,079 provide a method for controlling the fat content in milk by separation of the milk into a cream and a skim milk component. The two streams are then recombined in a desired ratio to provide a milk having the desired fat level. However, these patents are directed to the industrial production of milk products and is not suitable for retail use, or the like, where rapid changes of milk fat content on small samples is required.

U.S. patent publication No. 2001/0026825, published Oct. 4, 2001, and U.S. patent publication No. 2003/0054079, both provide high concentration milk products which can be chemically stabilized, and which can be mixed with water to produce various milk products. However, there is no mechanism to vary the ratio of milk solids to fat, or to produce a liquid dairy product having no fat content.

Accordingly, none of these approaches address all of the difficulties encountered with the provision of liquid dairy products, and in particular, the provision of a wide range of liquid dairy products in potentially very small volumes, in a retail environment. As such, the prior art devices do not allow for the rapid dispensing of liquid dairy products having selected milk fat ratios, which have been produced from various liquid dairy components, in order to provide the small volumes of the wide variety of liquid dairy products, which are commonly used in retail establishments.

Also, the prior art references do not address the issue of providing an intimate mixture of dairy products to produce the taste, texture, appearance, mouth “feel”, and “whitening” ability, of a wide range of commonly used dairy products, and thereby produce liquid dairy products having a quality which dairy product consumers have come to expect. Further, none of the references address the ability to provide small amounts of liquid dairy products in a sanitary or hygienic fashion, with the ability to rapid switch from one type of liquid dairy product to another.

As an example, it would be desirable to provide an apparatus to the retail market that would provide the ability to rapidly switch from dispensing 250 ml of 2% milk fat (M.F.) milk, to dispensing 15 ml of 35% M.F. cream and then to dispensing 30 ml of skim milk (0% M.F.), and provide the various products quickly, and without any significant blending between the final products, and without the need for a specific cleaning of the dispensing equipment between the dispensing of each product.

While it is also noted that the above named U.S. Pat. No. 3,987,715 does address the issue of cleaning of an ultrasonic mixing device by spraying water on the mixing device, this patent is directed to the cleaning of a device in a vending machine where a liquified product, such as soup or the like, is produced from water and a solid or powdered material. Accordingly, its use is primarily directed to a system to avoid build-up of solids or powdered material within the mixing chamber.

As such, it would be beneficial to provide an apparatus which is capable of dispensing a wide variety of liquid dairy products, in potentially small volumes, which would be able to provide some or all of the advantageous features described hereinabove.

### SUMMARY OF THE INVENTION

The advantages set out hereinabove, as well as other objects and goals inherent thereto, are at least partially or fully provided by the liquid dairy product dispensation system of the present invention, as set out hereinbelow.

Accordingly, it is a principal advantage of the present invention to provide a liquid dairy product dispensation device which will provide a wide range of liquid dairy products from two or more base components.

Accordingly, in one aspect, the present invention provides a liquid dairy dispensation system for providing a liquid dairy product comprising:

a packaging assembly configured and designed for storing at least a first and a second dairy component product, and preferably, a first and second liquid dairy products, in separate compartnents, wherein the dairy component and/or liquid dairy products are capable of forming a resultant liquid dairy product after being combined;

a mixing chamber having a mixer for mixing said first and second dairy component product, and preferably said first and second liquid dairy product, together to form said resultant liquid dairy product;

a component delivery assembly, preferably comprising a pump, for transferring said first and second dairy component product, and preferably said liquid dairy products, from said packaging assembly to said mixing chamber, and

a dispensing assembly for dispensing said resultant liquid dairy product from said mixing chamber

In a further aspect, the present invention also provides a liquid dairy product dispensation apparatus comprising a packaging assembly adapted to receive at least a first and a second dairy component product, and preferably, a first and second liquid dairy product,

a mixing chamber having a mixer for mixing a first and a second dairy component product, and preferably, said first and second liquid dairy product, together to from a resultant liquid dairy product;

a component delivery assembly, preferably comprising a pump, for transferring said first and second dairy component products and preferable said liquid dairy products to said mixing chamber; and

a dispensing assembly for dispensing said resultant liquid dairy product from said mixing chamber.

Optionally, the dispensation system or dispensation apparatus described hereinabove with respect to the present invention, can additionally comprise a water delivery system which is capable of adding water to said mixing chamber for dilution of said first or said second dairy component products, such as said first or second liquid dairy product, as well as for dilution of said resultant liquid dairy product. The water might also be used for cleaning of said mixing chamber and/or said dispensing assembly.

As such, the optional inclusion of a water component allows for a wider variety of liquid dairy products to be produced. The water might also be used to assist in cleaning of the mixing assembly and the dispensing assembly.

In a still further aspect, the present invention also provides containers for said fist and said second dairy component product, and preferably said first and second liquid dairy products, which containers are adapted to be placed within said packaging assembly.

In a yet still further aspect, the present invention also provides a method for the dispensation of a liquid dairy product prepared from at least two dairy component products, and preferably at least two liquid dairy product components, comprising:

providing and retaining at least a first and a second different liquid dairy products in separate compartments of a packaging assembly;

withdrawing a selected amount of each of said first and said second liquid dairy products from said compartments, and feeding the withdrawn liquid dairy products to a mixing chamber;

intimately mixing said first and second liquid dairy products together to form a resultant liquid dairy product; and

dispensing said resultant liquid dairy product from said mixing chamber.

In a preferred embodiment, the system, apparatus, and methods of the present invention provide a resultant liquid dairy product which has acceptable levels of water, milk solids and fat, which meet with various government and other regulatory bodies guidelines or regulations, in order to be treated as standard dairy products.

### BRIEF DESCRIPTIONS OF THE DRAWINGS

Embodiments of this invention will be described, by way of example only, in association with the accompanying drawings in which:

FIG. 1 is an exploded schematic of the elements of a preferred dispensation system;

FIG. 2 is a diagrammatic view of a preferred mixing chamber;

FIG. 3 is a perspective view of a preferred dispensation apparatus;

FIG. 4 is a schematic view of the dispensing apparatus;

FIG. 5 is a component flow diagram for the production of 21 ml of 2% milk;

FIG. 6 is a component flow diagram for the production of 21 ml of 18% milk; and

FIG. 7 is a schematic representation of the apparatus of FIG. 4, which has been adapted to undergo a cleaning procedure.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements,

It is expressly understood, however, that the drawings are for the purpose of illustration and description only and are not intended as a definition of the limits of the invention.

Further, in the present application, the term “dairy component product” is used to describe a product that can be used to contribute either milk solids or fat to a resultant dairy product. As such, the dairy component product preferably has at a combination of milk solids and fat, but can also provide a range of products including skim milk comprised of essentially only milk solids, to a semi-solid material known as “butter oil” having essentially 100% butter fat. Preferably, however, the dairy component product is a “liquid dairy product” which term is used to refer to liquid products made from milk. This would include products ranging in fat from 0% (skim milk) to up to about 50% or more of fat.

Further, the skilled artisan will be aware that this term might also apply to products not made of milk, per se, and thus can include liquid or liquefiable dairy products such as edible oil products or the like, which can be made as milk substitutes. As such the terms “dairy component products” and “liquid dairy products” can include products made from products such as soy oil, or the like.

Further, while most “dairy component product” and/or “liquid dairy products” would be expected to be produced from the milk from cows, in this application, the term is also intended to cover milk from other non-cow sources, such as for example goats or the like. Accordingly, while the present application is described with particular reference to the milk product from cows, the skilled artisan would be aware that the present application is equally applicable in other applications.

Also, any or all of the liquid dairy products may be a conventional milk product having a standard milk fat concentration (such as skim, 1%, 2%, 3.25%, 10%, 18% or 35%). However, since the present invention operates by blending of the two products, the range of resultant dairy products can be limited by the composition of the starting materials. Accordingly, it is preferred that the two liquid dairy products are selected from: 1) a skim milk base having little or no milk fats, and preferably a concentrated skim milk base having up to 4 or 5 times the standard amount of milk solids normally present in a typical, prior art liquid dairy product only; and, 2) a high milk fat liquid dairy product, such as for example, a 35%, 45% or even 60%, fat product.

As such, one of the two liquid dairy components is preferably skim milk having essentially no fat, and containing only water and milk solids. Typically, skim milk will have an MSNF (milk solids non fat) concentration of 8.5 to 9.5%, by volume, and this might be used if there is no water for dilution. However, If water is used as a diluent, than a stabilized, skim milk concentrate having an MSNF concentration of, for example of greater than 20%, more preferably of between 20 and 50%, and most preferably, between 25 to 47% can be employed. A preferred skim milk concentrate would be 3 to 5 times the normal concentration of skim milk, and thus would have a MSNF concentration of between 25.5 to 46.5%.

To prepare the stabilized skim milk concentrate, or in more general terms, any of the dairy component products, various stabilizers, emulsifiers, thickeners, buffering agents, colourants and the like, can be added to dairy component product. For example, buffering salts such as sodium hexametaphosphate (SHMP) might be added since the phosphate aids in delaying gelation, or kappa carrageenan can be added to provide improved viscosity or added “body” in a product considered to be too “thin”. Use of materials for modification of the dairy product properties is known to the skilled artisan.

Also, if desired, fat in the amount of up to, say, 0.3% by volume can be added to the skim milk concentrate in order to provide a liquid dairy product which, depending on the local government regulations, would fall within the “skim milk” classification, once diluted. This added fat, preferably in the form of butterfat, will aid in the processing of the skim milk concentrate by reducing foaming, reducing protein gelation, and increase whitening.

When designing the apparatus of the present invention, it is desirable to include at least one skim milk component (or a component having a very low fat content) in order to be able to supply skim milk as one of the resultant liquid dairy products available.

The second dairy component is preferably a liquid dairy product component having a fat content of greater than 25%, more preferably between 25 and 50% fat, and most preferably between 30 and 45% fat. This high fat component can be formed on an industrial scale by skimming a high fat cream portion from the milk of a separator, and then adding milk or milk solids in order to provide a desired milk fat content. Again, various stabilizers and the like can be added to the high fat component to aid in the stability of the product.

The second dairy component might also include a liquid or liquefiable butter oil product described hereinabove having essentially 100% fat However, while this type of material might reduce the amount of water shipped as part of one of the dairy component products, it would typically require a higher amount of milk solids to be contributed by using higher amounts of, for example, skim milk.

As such, the second dairy component is preferably a liquid dairy product which comprises between 25 and 50% fat, and more preferably, a liquid dairy product having between 35 and 45% fat. It should be noted, however, that for stability of the fat content of the fat-containing materials, it is also preferred to have a milk solids component present. Accordingly, when preparing a desired, resultant liquid dairy product, the amount of milk solids from the second dairy component would be included in the calculation (as would any fat content from the skim milk).

By combinations of these materials, a wide variety of products can be prepared having the desired milk fat content, as well as the necessary and/or desired milk solids content. Also, with the optional addition of water, the amount of water which must be transported as part of the component dairy products is reduced

While a combination of say 2% and 25% milk fat materials, might be used, in a preferred arrangement, a mixture of skim milk, and a high solids cream of say 45%, together with a method to provide additional water as required, would be used. Without being restricted to this particular embodiment, the invention will hereinafter be described with respect to this particular combination. However, the skilled artisan would be aware that other component arrangements are possible.

It should also be noted that the viscosities of the various dairy component products may vary. For example, cream is typically more viscous than skim milk. However, by use of appropriate pumps, as discussed below, the relative viscosities of the materials is largely irrelevant Typically, at the temperatures commonly encountered (eg. 2° to 25° C.), the products preferably have a viscosity of between about 0.1 cPs to 10,000 cPs, and more preferably, between about 200 cPs to 7,500 cPs.

The apparatus used in the practice of the present invention is able to provide a wide range of volumes depending on the various components selected for use. As such, the apparatus could dispense as little as 1 ml of resultant liquid dairy product, or it might be adapted to provide a continuous flow of resultant liquid dairy product until at least one of the component containers was empty. Preferably, however, the apparatus will typically dispense between 5 ml and 500 ml of resultant liquid dairy product, and more preferably between 10 and 100 ml of product. Still more preferably, the apparatus would be designed to dispense between 15 and 30 ml of resultant liquid dairy product.

The resultant dairy product would preferably be considered by the consumer to be essentially equivalent to a “fresh” milk product The term “fresh” as applied to milk herein means characteristics normally associated with fresh, pasteurized milk, whether it is in the categories of Fat Free, or skim (less than 0.21% fat), Low Fat (1% fat), Reduced Fat (2% fat), or Full Fat (3.25% fat). When purchased at a store, a consumer who recognize these materials as being fresh. In contrast, consumers would not recognize as being fresh those products sold as, for example, canned or condensed milk, reconstituted powdered milk, or the like. Other tests for “freshness” usually evaluate the major sensory characteristics of fresh milk which include (a) the presence or absence of visual defects, whether it has visibly separated or coagulated, or changed in color, (b) the aroma and taste, which together contribute to the flavor, (c) the texture and mouth feel, i.e., free of milk defects which may be described as watery, thin, coagulated, sandy, gritty, or separated, and (d) the ability of the product to suitably “whiten” a darker liquid such as coffee, tea or the like.

The dairy component products and/or liquid dairy products may require refrigeration in order to maintain their stability, and maintain their freshness. As such, transportation means, and the storage means for these products may require refrigeration capabilities. Further, the packaging assembly may be refrigerated and/or insulated to preserve the materials when in use in the method and/or apparatus of the present invention.

Preferably, however, the dairy component products have an extended shelf life (ESL), such as ESL pasturized, or are pasturized, or most preferably are “aseptic” so as to eliminate the need for refrigeration; particularly during transportation or storage. The aseptic product might, however, still be refrigerated prior to, or in use in order to suit the consumer's preferences for a cold dairy product.

Preferably, the aseptic product will be able to provide a shelf life of at about 180 days, meaning that the liquid dairy product is able to produce a product after 180 days which has an property profile similar to that of fresh product. This type of product is hereinafter referred to as “aseptic” or aseptically packaged” liquid dairy product.

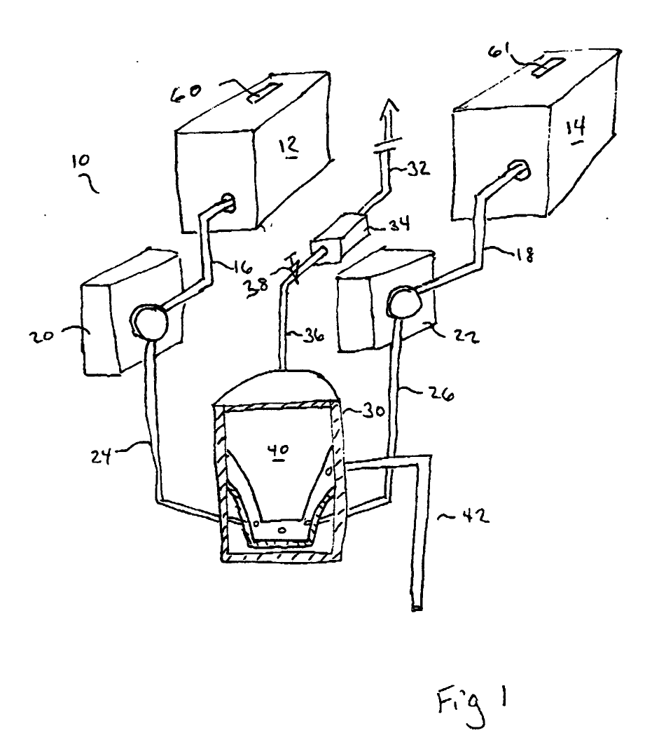

Referring to FIG. 1, a liquid dairy dispensation system 10 for providing a liquid dairy product of use in the practice of the present invention is shown in an exploded schematic view.

System 10 has two containers 12, 14 for holding a first and second liquid dairy products. In this embodiment container 12 holds a skim milk concentrate (hereinafter “skim milk component”) having 3 times the normal MSNF components of skim milk (e.g. the concentrate has 0% fat, and 26% milk solids). Container 14 holds a concentrated dairy product (hereinafter the “cream component”) having 35% fat, and 8.5% milk solids.

Containers 12 and 14 can be identically shaped, and can have the same volume and the like. Alternatively, the containers can be different sizes in order to differentiate the skim milk component from the cream component. However, in order to differentiate the higher fat content container from the lower fat content container, it is preferred that the containers have projections, grooves and the like to prevent accidental misplacement of the container in a wrong compartment of the system apparatus.

The container might also contain some method to identify the contents of the container. For example, the container might be colour-coded, or the like in order to group similar products in like groups. In a preferred embodiment, containers 12 and 14 will each contain a RFID chip 60 and 61, respectively, or some other identification markings, which will specifically identify the container, and/or which can provide specific information on the dairy product component of the specific container. This feature will assist in control of the system of the present invention, as discussed further hereinbelow.

Also, while containers 12 and 14 are shown as being two separate containers, it should be noted that they might also be two separated portions of a single container, with each portion having a separate outlet.

Further, the capacities of each container may vary greatly, depending on a number of factors, e.g., such as the concentration of the product, the overall size of the apparatus, or the relative amount of material expected to be used. For example, in applications where mostly cream is used, the size of the cream component container could be larger, whereas in a situation where mostly 2% milk was used, the size of the skim milk component might be larger. In one embodiment, the containers hold between about 50 ml and 10 litres, preferably between about 100 ml and 5 litres, and more preferably between about 200 ml and 4 litres. In a preferred embodiment, the ratio of the size of each container falls within the range of between about 5:1 and 1:1. Most preferably, the size of each container is essentially the same.

Containers 12 and 14 can merely be solid plastic containers which are adapted to fit within the apparatus. However, they may also be collapsible and/or disposable pouches made from, for example, barrier films which are able to keep water vapor, oxygen, and light transmission to a minimum. Suitable barrier films are commercially available, for example, containing laminated layers of polyester/aluminum/polyethylene, or the like.

The skim milk component and the cream component from containers 12 and 14 are each pumped from their respective containers using a component delivery assembly. The component delivery system in this embodiment consisting of tubes 16 and 18 which take product from containers 12 and 14 respectively, pumps 20 and 22, and tubes 24 and 26 through which the output of pumps 20 and 22 are fed to mixing chamber 30.

It is to be noted that tubing 16 and 18, and all tubing used herein, are preferably flexible tubes which are suitable for use with food products, and in particular, dairy products. These types of tubes are well known in the industry, and can include tubes of flexible polymeric materials, which are commonly used for contacting and dispensing consumable beverages. Examples of suitable piping include food grade plastics, such as PTFE, PE, HDPE, PP, PVC, silicones, and the like. For example, tubing sold under the trade marks “Tygon” and “Norprene” are examples of the type of tubing that might be utilized.

Further, tubes 16 and 18 preferably connect to containers 12 and 14 using releaseable, and preferably, aseptic couplings (not shown) which would allow containers 12 and 14 to be rapidly replaced, when needed. In a preferred arrangement, the coupling used on tube 16 will be different from the coupling on tube 18, and thus, a incorrect connection to containers 12 and 14 can be avoided.

Pumps 20 and 22 can be eliminated from the component delivery system if gravity feed is used, or if a pressurized system is used to move the liquid components. However, for accurate control and ease of use, it is preferred that pumps 20 and 22 be present. Any suitable pump can be used. A preferred type of pump, however, is a positive displacement pumps, and most preferably, the pump is a peristaltic pump. Peristaltic pumps are preferred since they can be accurately controlled (with respect to delivery timing and volume), and since, in this type of pump, the liquid dairy product components will not contact the pump components, per se, but remain within the tubing. This assists in minimizing the need for any cleaning of the pump, and minimizes the possibility of contamination of the dairy products from the pump components.

In a peristaltic pump, the liquid is moved by the action of the squeezing of the tube by the action of rollers or “fingers” on the tubing. The motor for the pump is preferably a “stepper” motor which can be accurately controlled to dispense a precise amount of liquid.

In the embodiment described herein, water is taken from a pressurized water supply, such as a city potable water supply, through tube 32 to a water treatment device 34. While treatment of the water may not be required, it is shown in this embodiment to acknowledge that some water supplies are required to be treated for either health concerns, for taste preferences, or for similar reasons. The water treatment device can include devices such as filters, activated carbon filters, reverse osmosis (RO) membranes, water softeners, UV sterilizers, pressure valves, and the like, but in this example, water treatment device 34 is simply an RO membrane.

The water treatment can be done prior to feeding the water to the apparatus used in the present invention, or alternatively, various water treatment components can be included as part of the apparatus of the present invention.

Water exiting treatment device 34 is fed, as a result of the city water pressure, through tube 36 to mixing chamber 30. Valve 38 on tube 36 is used to control the flow of water to the mixing chamber 30, while pumps 20 and 22 are used to control the amount of product from containers 12 and 14 which flows into mixing chamber 30. Alternatively, valve 38 can be replaced by a third pump which will pump precisely controlled amounts of water into the mixing chamber.

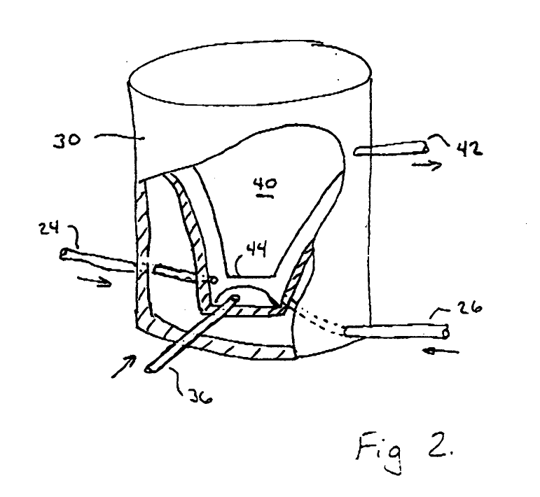

Mixing chamber 30 is a hollow cylindrical shell, which is shown in a cut-away view in FIG. 1, and is shown in greater detail in FIG. 2. Suitable mixing chambers can be any suitable vessels which might be used to mix the dairy component products, and optionally water, and can be made of any suitable material. Preferably, however, it is made of made of a material which would be suitable for food applications, and could include materials such as glass, stainless steel, glass lined products, or the like.

The mixing chamber is preferably a closed system in that the only ready access to the mixing chamber is through the tubes used to pump the dairy component products into the chamber, the water inlet (if used), and the resultant product outlet. As such, foreign objects or liquids will not fall into the mixing chamber, and thus, contamination of the resultant product in the mixing chamber is avoided. Further, however, the mixing chamber is preferably easily disassembled with the proper tools, in order to facilitate inspection, or routine intensive cleaning.

Once the dairy product components, and optionally water, have been introduced into mixing chamber 30, they are preferably mixed using a mixing device. A variety of mixing devices might be utilized, and these can include a wide variety of mechanical mixers, including rotating mixing blades, static mixers, and the like. However, in order to provide a resultant liquid dairy product have good properties similar to a fresh dairy product, it is particularly preferred that the mixing device be an ultrasonic mixing device, which is placed within the mixing chamber.

In the preferred embodiment, shown in FIG. 1, and in more detail in FIG. 2, the ultrasonic mixing device is preferably a rod-shaped “sonotrode” 40 which is inserted into a cylindrically shaped mixing chamber 30 so as to provide intimate contact between the sonotrode and the components added to the mixing chamber.

A preferred type of mixing chamber, with a sonotrode as a mixing device, is commercially available from Hielscher GMBH and sold under the “UIP” trade mark, although other ultrasonic mixers might also be used. The ultrasonic mixers are available with a variety of power consumption ranges, and the skilled artisan will be able to select a power range appropriate for the size of mixing chamber to be utilized in the apparatus.

Without being bound by theory, it is believed that the ultrasonic mixer provides a small area of intense turbulence and cavitation which acts to intimately mix the dairy components on a molecular level. As a result of this intense mixing, the resultant dairy product is not only reconstituted, it is recombined.

In a “reconstituted” dairy product, the milk solids and the fat components are both present in the skim milk phase, but there is little intimate nixing, on a molecular level, of the milk solid content, and specifically, the proteins and minerals present, present in the skim milk phase, with the fat globules. As such, they are prone to “phase separation” of one component from another, by, for example, settling, agglomerating, aggregating, solidifying, liquefying, forming a precipitate, forming another liquid phase, or in some other way causing an unevenly or non-uniformly mixed product to result. This can occur at any time after the components are mixed together and/or any time after the component mixture is dispensed.

In a “recombined” dairy product however, the proteins from the milk solids component are intimately mixed, and forms bonds with and/or around the fat globules. As a result of this recombination, the intimate inclusion of the protein in the fat globules assists in stabilizing the fat globule within the aqueous skim milk phase. As such, the recombined liquid dairy product has improved stability over other dairy products which have merely been reconstituted, and provides a material which more closely resembles a fresh dairy product.

Accordingly, mixing with an ultrasonic mixer assists in reestablishing a recombined dairy product since it is able to mix the component materials together, in a non-destructive manner, in a more effective manner than other types of commonly used mixing methods. This is done, in the present invention, on a small scale, in order to rapidly produce a variety of different liquid dairy products from concentrated components, all of which have properties similar to traditional dairy products.

Thus, an ultrasonic mixer is preferred since with this type of ultrasonic mixer in the mixing chamber, the degree of homogenization, that is, the degree to which the fat globules have been dispersed in the skim milk phase approaches that of homogenized milk products with respect to the size and the consistency of the size of the fat globule dispersion. By approaching the same degree of homogenization of homogenized milk products, the colour, taste, appearance, feel, whitening ability, and the like, of the resultant product will more closely approximate fresh milk.

As such, the resultant material will preferably have a degree of homogenization which will be approximately equal to that of commercial milk products having a similar fat content. The following properties with respect to its degree of homogenization:

Mixing chamber 30 also has a series of openings to allow the water and the skim milk and/or the cream components to enter the mixing chamber, where they are mixed together, and/or mixed with the water. Sonotrode 40 is adapted to fit into mixing chamber 30 so as to leave a small gap between the interior wall of the shell of the mixing chamber 30, and the exterior wall of the sonotrode 40. As such, with the sonotrode 40 inserted in place, the mixing chamber 30 typically holds a volume of approximately 5 ml, although larger or smaller mixing chambers can be used depending on the particular application, and the expected flow rates and volumes.

With respect to the design of the mixing chamber, the size of the orifices of the openings in the mixing chamber, as well as the size of the tubing used throughout, and the pump sizes, can be varied according to various factors such as the viscosity, desired flow rate, and expected total amounts of the component(s) to be used, as well as the relative ratio of the components to be used Proper selection of these design configurations would be clearly understood by those skilled in the art.

At the bottom of sontrode 40 is a “sonic membrane” 44 which acts to transmit the ultrasonic frequencies used for mixing of the liquids. As such, liquids enter the mixing chamber 30 in the vicinity of sonic membrane 44, and are mixed together by ultrasonic mixing. After mixing, the liquids are propelled up between the walls of the sonotrode and the mixing chamber shell, and then exit chamber 30 through tube 42.

Tubes 24, 26 and 36 are all shown separately entering mixing chamber 30. This arrangement is preferred in order to minimize “contamination” of the skim or cream components prior to entry into mixing chamber 30. However, it will be clear to the skilled artisan that any or all of these delivery tubes can joined to one another outside of the mixing chamber 30. All of these tubes enter the mixing chamber 30, at or near the bottom of the chamber.

Tube 42, which carries the resultant dairy product, exits from mixing chamber 30 at or near the top of the mixing chamber in order to promote an upward flow of liquid in the mixing chamber 30, and thus further assists in mixing of the liquids by maintaining a level of liquid within the mixing chamber. The amount of liquid held in the mixing chamber can vary depending on its size and design, but typically will have a volume which ranges from 1 ml to 25 ml, preferably from 2 to 10 ml, and more preferably, from 4 to 6 ml.

Between uses, mixing chamber 30 may contain a small amount of residual liquid, but this would be a small amount, and in a preferred embodiment, will likely be essentially water, as will be explained hereinbelow.

After the components are mixed, the resultant product exits mixing chamber 30 through tube 42. While tube 42 may additionally contain a valve to contain the output from mixing chamber 30, preferably, the resultant product flows freely from mixing chamber 30 though tube 42.

Also, while a pump or a pressurized system might be connected to tube 42 to move the resultant product from mixing chamber 30, preferably, the resultant product flows out of mixing chamber 30 merely by the force of the incoming liquids, and then flows through tube 42 as a result of the force of gravity. As such, tube 42 preferably slopes downward from mixing chamber 30 to the terminal point of tube 42. When the resultant dairy product exits tube 42, it is ready for collection and use as the final dairy product.

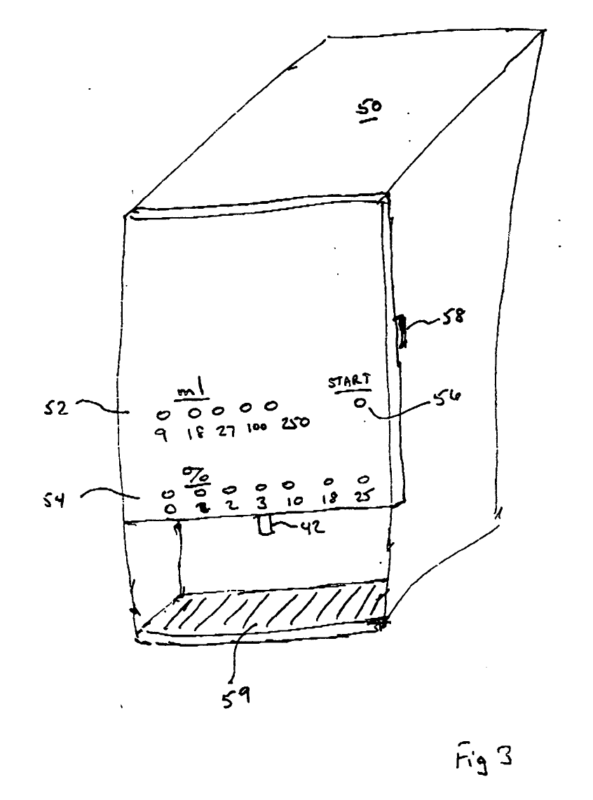

In FIG. 3 a representative view of the outside of an apparatus 50 for operation of the dispensation system 10 of the present invention is shown, and in particular, the face 51 of the apparatus. Apparatus 50 has two sets of selection buttons 52 and 54 which provide control over the volume of liquid dairy products to be produced 52, and the butter fat content of the liquid dairy product 54. A start button 56 is also provided, as well as the terminal, output end of tube 42. In operation, the user would select the type of dairy product desired using button set 54, and then select the volume of liquid dairy product using button set 52. Once these controls have been set, the user merely hits start button 56 to dispense the liquid dairy product.

In will be clear however, that other arrangements can be provided in order to select the appropriate type and amount of product. For example, buttons could be pre-programmed to provide a set volume of a selected type of liquid dairy product (e.g. 21 ml of 2% milk).

Latch 58 is shown on the side of apparatus 50 which allows the front panel to be moved in order to gain access to the interior of apparatus 50 in order to change containers 12 and 14, or to conduct maintenance, cleaning, or the like. Finally, a tray section 59 is shown to collect any spilt materials.

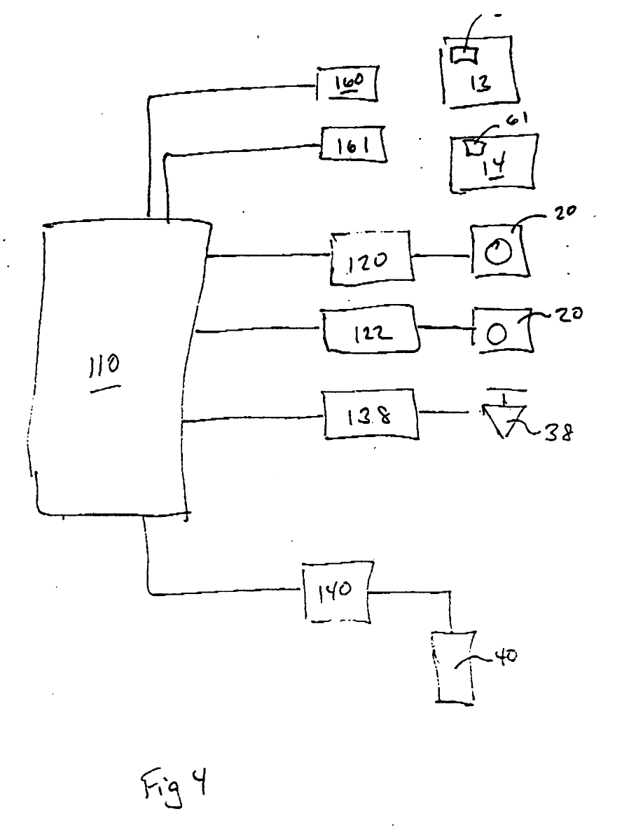

While the apparatus of use in the system of the present invention might operate solely by use of mechanical linkages and other arrangements, it is preferred that the various components are controlled by a computerized system. In FIG. 4, a schematic representation of a computerized control system is show, which would be of use in the system 10 shown in FIG. 1.

In FIG. 4, sensors 160 and 161 are located in the apparatus near to the location of RFID chips 60 and 61, respectively, and are thus are able to read the information from chips 60 and 61. Preferably, sensors 160 and 161 are able to read the information without needing to be directly connected to chips 60 and 61.

The information from chips 60 and 61 is passed to a central, computerized controller 110. This information can include such information as the level of fat, the level of milk solids, a product expiry date, or the like, and this information can be used by the controller to extract the exact amount of the cream or skim milk components necessary, and to ensure that the components are still acceptable for use. By using the information from chips 60 and 61, the central controller is able to precisely calculate the ratios of the water and dairy component products needed to exactly match the desired resultant liquid dairy product. This system also permits for a variety of dairy product component concentrations to be used, and thus minimizes the need for exact control of their concentration.

Sensors 152 and 154 are connected to button sets 52 and 54 respectively, and are used to determine the desired amount of material, and type of dairy product to be produced. Again these sensors are linked to central controller 110 so that this information can be provided to controller 110. Also, central controller 110 is linked to start button 56 in order to activate the system, when required.

Pump controllers 120 and 122 are used to accurately time when pumps 20 and 22 are switched on and off, and, optionally, the flow rate at which pumps 20 and 22 will operate. Pumps 20 and 22 may require “calibration” in order to ensure that precise volumes are being dispensed. This calibration could be controlled by pump controllers 120 and 122, or by central controller 110.

Valve controller 138 is connected to valve 38 and is used to control the timing, amount, and optionally the flow rate, of the water entering the mixing chamber. Again, valve controller 138 is linked to central controller 110, and may require calibration, or calibration controls.

Finally central controller 110 is also linked to a sonotrode controller 140, which turns sonotrode 40 on and off at appropriate times.

In operation, buttons in button sets 52 and 54 are set to their desired position, and this information is provided to central controller 110 using sensors 152 and 154, so that central controller knows the type of dairy product desired, and the amount desired. Once start switch 56 is activated, central controller calculates the amount of each of the water, and the skim milk and cream components from containers 12 and 14. This calculation is based on the information taken from chips 60 and 61 collected by sensors 160 and 161.

Once the formulation for preparing the desired product has been calculated, central controller activates pump controllers 120 and 122, and water valve controller 138 in order to provide a mixture of 2 or 3 of the components in the mixing chamber. Once liquid is in the mixing chamber, sonotrode 40 is activated using sonotrode controller 140 in order to mix the components together.

By way of example, in the practice of the present invention, in order to provide a consumer with skim milk, the skim milk concentrate would be diluted with water, and no milk fat component needs to be added. For example, 2 parts by volume of water would be mixed with 1 part by volume of a 25.5% MSNF concentrate of skim milk to product a resultant skim milk product having milk solids of 8.5%. However, a small amount of the high fat content material might be added to provide some property enhancements (such as colour enhancement, or the like), while still meeting the government guidelines or regulations for skim milk fat levels.

In order to prepare a non-skim milk type product, the high fat content component is also mixed with the skim milk component and optionally water to produce a liquid dairy product having the desired milk fat content, and the necessary Or desired milk solid content. For example, to produce a 2% milk product, 20.6% of a 3 times (3×) concentration of skim milk would be combined with 5.7% of a 35% cream material, and 73.7% water (all by weight), in order to produce the desired resultant 2% milk product. This mixture would be added to the mixing chamber using controllers 120, 122 and 138, and the sonotrode 40 would be activated using controller 140.

Use of the computerized system described in FIG. 4 allows for precise timing of the addition of liquids to the mixing chamber. In a preferred method, the timing of the addition of these components is controlled in order to provide the ability to maintain a sanitary and hygienic environment in the mixing chamber, the component delivery assembly, and/or the dispensing assembly, and preferably, in all three of these areas.

This is preferably achieved by controlling the timing of the addition of the water to the mixing chamber in order to provide a rinse of the mixing chamber at the end of each dispensing cycle.

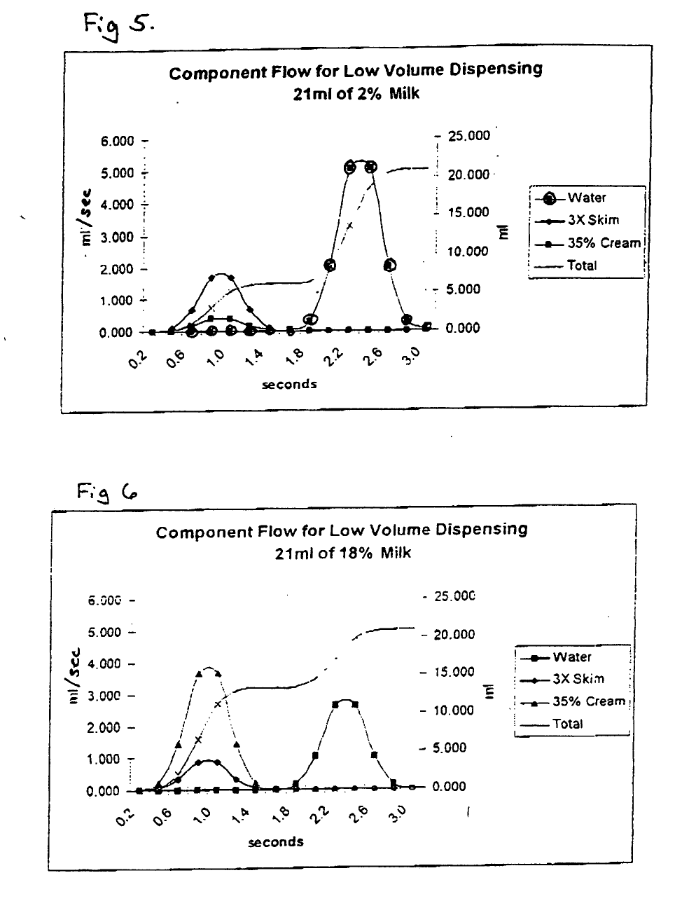

For example, in FIG. 5, a flow diagram for the production of 21 ml of 2% milk is shown from a mixture of an aseptic, 3 times concentrate of skim milk component (having 25.5% MSNF), an aseptic 35% fat cream component, and an appropriate amount of water, in an apparatus as shown and discussed in FIGS. 1 to 4.

In FIG. 5, the bottom axis shows the timing of the addition of the component, and in this example, the resultant dairy product is produced over a 3 second period. The left axis shows the flow rate of the addition of the components to the mixing chamber in ml/sec while the right axis is used to show the total volume of liquid added to the mixing chamber. The mixing chamber has a volume of 5 ml, and thus has a residual volume of essentially clean water from a previous cycle. This residual water content will vary in amount depending on the location of the exit location of tube 42 on the mixing chamber.

Once start button 56 is pressed, the skim milk component and the cream component are added to the mixing chamber, and the sonotrode ultrasonic mixer is activated to mix the liquids together in order to form a recombined dairy product. As liquid enters the mixing chamber, liquid also begins to exit the chamber starting first with the residual water, and followed by the recombined dairy product. After 1.5 seconds, a combined total of 6 ml of skim milk component and cream component have been added to the chamber and mixed to form the recombined dairy product.

Over the next 1.5 seconds, 15 ml of water is added to the mixing chamber, and preferably, the sonotrode ultrasonic mixer continues to operate in order to dissolve any dairy components remaining in the mixer in the incoming water stream. As such, near the end of the water addition, virtually all of the dairy components have been flushed from the chamber and have exited through the dispensing tube. All of the liquid exiting the mixing chamber is collected in order to form the desired dairy product.

After the total 3 second period, a mixture has been dispensed which accurately simulates the desired dairy product. The water exiting the mixing chamber at or near the end of the cycle easily mixes with the recombined milk product which has previously exited the mixing chamber.

On completion of the cycle, the mixing chamber is again filled with approximately 5 ml of clean residual water and is ready for production of the next dairy product.

The skilled artisan would be aware that the size of the mixing chamber can be varied in order to provide acceptable residual volumes of water. For example, an apparatus used to prepare 250 mls of a milk material would tolerate a higher residual volume in the mixing chamber than an apparatus designed to provide 15 ml of material at a time.

Also, the skilled artisan would be aware that devices such as check valves can be used to prevent, or better control the flow of liquids within the apparatus.

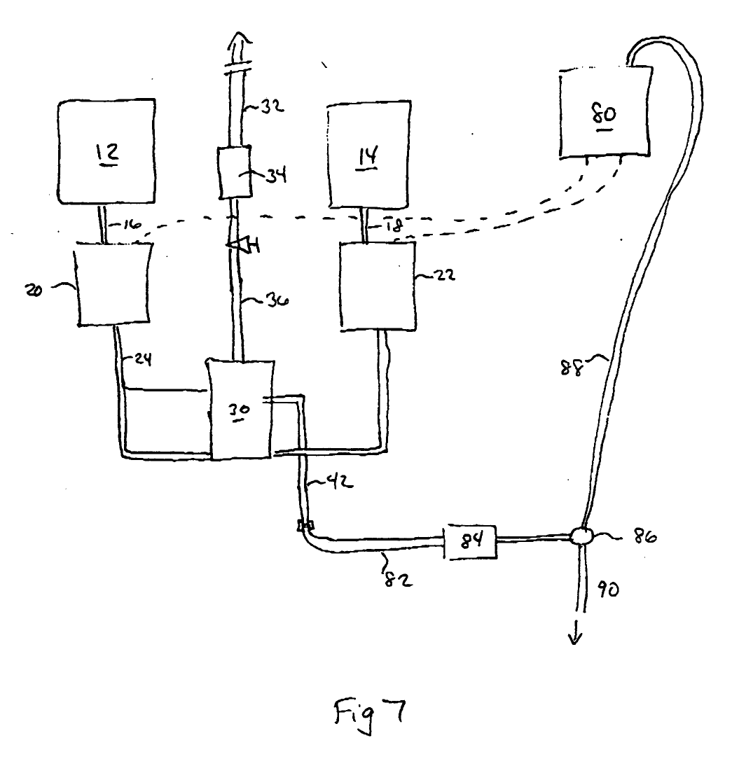

In FIG. 6, a similar flow diagram for the production of 21 ml of 18% milk is shown, which could be produced immediately following the production of the 2% material described with respect to FIG. 5. In FIG. 6, increased amounts of the skim milk component, and in particular, the cream component are added to the mixing chamber, with its residual water content, and mixed in the first 1.8 seconds. The total amount of dairy products added is approximately 14 ml. In the final 1.2 seconds, 7 ml of water is added to the mixing chamber in order to flush the dairy product from the mixing chamber, and leave essentially clean residual water in the mixing chamber.

Those skilled in the art will appreciate that the amount of residual water, the flow rates of product addition, and the like can all be varied by minor modification of the mixing chamber design, and the like. The flow rate of the water and the dairy product components can vary greatly, depending on any of the previously stated conditions or properties, such as those indicated above. In a preferred embodiment, however, each volumetric flow rate is from about 0.1 ml/min to 100 ml/min, preferably from about 0.5 ml/min to 50 ml/min, and even more preferably about 2 ml/min to 35 ml/min. However, it will be clear that the flow rates will vary depending on the design parameters of the apparatus.

Also, those skilled in the art will also appreciate that further components can be added so as to include more than 2 dairy components, and thus, increase the flexibility of the apparatus. Also, the beverage product to be dispensed may include other materials, such as flavouring, or other components which are desired to give the resultant dairy product additional properties. Further, while it is preferred that the resultant dairy product meet the local requirements for substitution of regular dairy products, this is not essential. Instead, customized dairy “blends” could be produced having relatively higher or lower fat levels and fat level to milk solids ratios.

Still further, the skilled artisan will also appreciate that the dispensing apparatus might also contain other non-essential features which provide some functional or aesthetic benefits, such as, for example, a hot or cold water taps, component level indicators, alarms, digital displays of the apparatus settings and conditions such as temperature, reminders concerning pump or valve calibration or the timing of routine intensive cleaning, and the like.

Yet still further, the skilled artisan will be aware that the volume of the mixing chamber might be adjusted in an apparatus by various means. These might include relative movement of the sonotrode within the mixing chamber to reduce or enlarge the area between the sonotrode and the mixing chamber. This might also be accomplished by changing the wall positions of the mixing chamber using a moveable section wherein, for example, the “floor” of the mixing chamber could be raised to decrease the volume of the mixing chamber, or the like.

Also, the skilled artisan will be aware that, although routine use of the apparatus will maintain a sanitary environment, regular cleansing of the apparatus would likely also be desirable. This can be accomplished by, for example, the configuration shown in FIG. 7. In FIG. 7, a schematic representation of the system of the present invention is shown in which, inter alia, a separate cleaning tank 80 is also provided Tank 80 can be positioned within apparatus 50 after containers 12 and 14 have been temporarily removed, and tubes 16 and 18, both, or individually, are connected to tank 80. Also, dispensing tube 42 is connected to extension tube 82 which passes through a heater module 84, and a then meets with ree-way valve 86. The liquid passing though tube 82 can then be sent via tube 88 to the top of tank 80, or can be sent to a drain by tube 90 by movement of valve 86.

In use, containers 12 and 14 are disconnected from the system, and tank 80 is connected to tubes 16 or 18, but preferably to both tubes 16 and 18. Tank 80 is preferably of a size where it can be placed within the space vacated by containers 12 and 14. Tank 80 is filled with rinse water, and preferably a cleaning solution. Pumps 20 and 22 are then operated in a continuous mode to pull cleaning solution from tank 80 through tubes 16 and 18, and then sent it to mixing chamber 30, and then through dispensing tube 42. An initial portion of cleaning solution can be sent to drain through tube 90.

After this initial rinse period, heater module 84 is engaged to heat the cleaning solution to a suitable temperature such as 90° C. Also, valve 86 is moved so that the heated cleaning solution is recycled and returned to tank 80. The heated liquid can be sent to the tubes and mixing chamber components in order to sanitize these components.

After a sufficient period of time, heater module 84 is turned off, and valve 86 is turned so that the heated cleaning solution is drained from the system through tube 90. Tank 80 is then filled with clean, cool rinse water, and pumps 20 and 22 are used to circulate the clean water throughout the system, and to cool the system. This rinsing operation may be repeated in order to remove any traces of the cleaning solution from apparatus 50.

The skilled artisan will also be aware that residence time in the mixing chamber will ultimately determine the degree of homogenization of the resultant product. However, it is preferred that the mixing chamber, with mixer, be designed so that homogenization of the product is accomplished essentially instantaneously as the components preferably flow continuously through the mixing chamber. Thus, the residence time in the mixing chamber will preferably average less than 10 seconds, more preferably less than 5 seconds, and most preferably, be less than 2 seconds.

### EXAMPLES

### Example 1

A 2% M.F. product was prepared in accordance with the present invention from a 3× concentration mixture of skim milk, and a 35% cream material. Sufficient water was added to produce the desired resultant product.

This product was compared to a control mixture that had been simply hand blended under low shear conditions. In general, the product prepared using the method and apparatus of the present invention provided scores 5% closer to standard milk with respect to colour (namely “L, a, b” scores) than did the control mixture. Further the product prepared using the method and apparatus of the present invention provided a particle size distribution that was 22% closer to standard milk than did the control.

Finally, on standing in a pyrex beaker, the product prepared using the method and apparatus of present invention did not leave a skim solids line on the beaker after standing, similar to the performance of regular milk. However, the control mixture left a substantial skin solids line on the beaker surface.

### Example 2

A first 2% milk sample was prepared from a blend of 3× skim milk concentrate, 35% cream and water (Formula A) in a second dispersion apparatus. A second 2% milk sample was prepared from regular skim milk, 35% cream and water (Formula B). These samples were compared to a commercial 2% milk sample (Target), and a hand blended control sample (Control) with respect to colour and particle size. The products were also compared for their ability to colour coffee in a 2% milk blend in coffee. The results are shown in Table 1.

TABLE 1

| | | | | Particle Size | |
|---|---|---|---|---|---|
| | Colour | | | Mean | Spec. Surface |
| Sample | L | a | b | Diameter (μm) | Area (m²/ml) |
| Target | 77.89 | −2.37 | 2.62 | 0.86 | 10.06 |
| Control | 74.22 | −2.56 | 0.57 | 2.46 | 7.46 |
| Formula A | 78.61 | −2.39 | 1.41 | 0.91 | 11 |
| Formula B | 79.40 | −2.73 | 2.40 | 0.83 | 14.6 |
| Coffee & | 44.56 | 2.45 | 13.8 | | |
| Target | | | | | |
| Coffee & | 39.69 | 1.57 | 10.7 | | |
| Control | | | | | |
| Coffee and | 44.97 | 2.55 | 13.96 | | |
| Formula A | | | | | |
| Coffee and | 45.27 | 2.58 | 13.62 | | |
| Formula B | | | | | |

The results show that the recombined and reconstituted products, which have been prepared in accordance with the present invention, have properties significantly improved over a simple hand blended mixing procedure, and have final properties which approach that of traditional standard milk products.

Thus, it is apparent that there has been provided, in accordance with the present invention, a liquid dairy product dispensation system which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively, and, the term “about,” as used herein with respect to a range of values, should be understood to modify either value stated in the range, or both.

Also, while this discussion has addressed prior art known to the inventor, it is not an admission that all art discussed is citable against the present application.

1. A liquid dairy dispensation system for providing a liquid dairy product comprising:
a packaging assembly configured and designed for storing at least a first and a second dairy component product in separate compartments, wherein the dairy component products are capable of forming a resultant liquid dairy product after being combined;
a mixing chamber having a mixer for mixing said first and second dairy component product together to form said resultant liquid dairy product, which resultant liquid dairy product is reconstituted and recombined;
a component delivery assembly for transferring said first and second dairy component product from said packaging assembly to said mixing chamber; and
a dispensing assembly for dispensing said resultant liquid dairy product from said mixing chamber.

2. A liquid dairy dispensation system as claimed in claim 1 additionally comprising a water delivery system which is capable of adding water to said mixing chamber for dilution of said first or second or dairy component product, or for cleaning of said mixing chamber or said dispensing assembly.

3. A liquid dairy dispensation system as claimed in claim 1 wherein said first and second dairy component products are both liquid dairy products.

4. A liquid dairy dispensation system as claimed in claim 1 wherein said component delivery assembly comprises a pump.

5. A liquid dairy dispensation system as claimed in claim 1 wherein said mixer is an ultrasonic mixer.

6. A liquid dairy dispensation system as claimed in claim 5 wherein said ultrasonic mixer is a sonotrode.

7. A liquid dairy dispensation system as claimed in claim 1 wherein said first dairy component product is a skim milk base product.

8. A liquid dairy dispensation system as claimed in claim 1 wherein said first dairy component product has a MSNF content of between 5 and 50%.

9. A liquid dairy dispensation system as claimed in claim 8 wherein said first dairy component product has a MSNF content of between 10 and 40%.

10. A liquid dairy dispensation system as claimed in claim 8, wherein said first dairy component product has a MSNF content of between 20 and 30%.

11. A liquid dairy dispensation system as claimed in claim 7 wherein said first dairy component product has a fat content of less than 0.3%.

12. A liquid dairy dispensation system as claimed in claim 1 wherein said second dairy component product has a fat content of greater than 20%.

13. A liquid dairy dispensation system as claimed in claim 12 wherein said second dairy component product has a fat content of between 10 and 60%.

14. A liquid dairy dispensation system as claimed in claim 12 wherein said second dairy component product has a fat content of between 20 and 45%.

15. A liquid dairy product dispensation apparatus comprising:
a packaging assembly comprising a first and second container holding a first and a second dairy component product;
a mixing chamber having a mixer for mixing a first and a second dairy component product together to form a resultant liquid dairy product which resultant liquid dairy product is reconstituted and recombined;
a component delivery assembly for transferring said first and second dairy component products to said mixing chamber; and
a dispensing assembly for dispensing said resultant liquid dairy product from said mixing chamber.

16. A liquid dairy dispensation apparatus as claimed in claim 15 additionally comprising a water delivery system which is capable of adding water to said mixing chamber for dilution of said first or second dairy component product, or for cleaning of said mixing chamber or said dispensing assembly.

17. A liquid dairy dispensation apparatus as claimed in claim 15 wherein said first and second dairy component products are both liquid dairy products.

18. A liquid dairy dispensation system as claimed in claim 15 wherein said component delivery assembly comprises a pump.

19. A liquid dairy dispensation system as claimed in claim 1 wherein said mixer is an ultrasonic mixer.

20. A liquid dairy dispensation system as claimed in claim 19 wherein said ultrasonic mixer is a sonotrode.

21. A container for use in a liquid dairy dispensation apparatus wherein said container is adapted to be placed within said packaging assembly within an apparatus as claimed in claim 10.

22. A container as claimed in claim 21 wherein said container comprises an RFID chip.

23. A container as claimed in claim 21 wherein said container is a collapsable container.

24. A method for the dispensation of a liquid dairy product prepared from at least two dairy component products comprising:
providing and retaining at least a first and a second different dairy component products in separate compartments of a packaging assembly;
withdrawing a selected amount of each of said first and said dairy component products from said compartments, and feeding the withdrawn dairy component products to a mixing chamber;
intimately mixing said first and second liquid dairy products together to form a resultant liquid dairy product, which resultant liquid dairy product is reconstituted and recombined; and
dispensing said resultant liquid dairy product from said mixing chamber.

25. A method as claimed in claim 24 wherein said first and second dairy component products are both liquid dairy products.

26. A method as claimed in claim 24 wherein said component delivery assembly comprises a pump.

27. A method as claimed in claim 24 wherein water is added to said mixing chamber in addition to said withdrawn dairy component products.

28. A method as claimed in claim 24 wherein said resultant liquid dairy product meets government regulations in order to be treated as a standard dairy product.
